(19) United States
(12) Patent Application Publication
(10) Pub. No.: US 2018/0350215 A1
(43) Pub. Date: Dec. 6, 2018

(54) MULTI-FUNCTIONAL NETWORK CAMERA CONTROL APPARATUS

(71) Applicant: FITIVISION TECHNOLOGY INC., New Taipei City (TW)

(72) Inventor: Ming-Hung Hsieh, New Taipei City (TW)

(21) Appl. No.: 15/613,150

(22) Filed: Jun. 3, 2017

(51) Int. Cl. G08B 13/196; H04M 1/02; G08B 7/06; G08B 25/12; H04N 5/232

(52) U.S. Cl. CPC G08B 13/19636; G08B 13/1963; G08B 13/19663; G08B 13/19684; H04N 5/23296; G08B 13/19695; H04M 1/0291; G08B 7/064; G08B 25/12; G08B 13/19689

(57) ABSTRACT

A multi-functional network camera control apparatus includes at least one network camera device, at least one camera module, at least one first computation processing device, at least one wireless network communication device, at least one first wireless transceiving device, a wireless key operation device, at least one key module, at least one second computation processing device and at least one second wireless transceiving device. Accordingly, a user is able to control the network camera device via the wireless key operation device or a mobile device.

### TECHNICAL FIELD OF THE INVENTION

The present invention is related to a multi-functional network camera control apparatus, in particular, to a multi-functional network camera apparatus capable of allowing a multi-functional network device to be controlled remotely in order to achieve the effect of monitoring and surveillance.

### DESCRIPTION OF THE PRIOR ART

Modern doorbells are typically electronic doorbells such that visitors can press the buttons on the door in order to notify house owners via electronic bells. In addition, since the speaker of the electronic bell is installed inside the house such that the sound generated is relatively clear. In addition, to prevent burglary from occurring, doorbell intercoms equipped with cameras are available in the modern society such that when the electronic bell generates sound, the house owner is able to view the visitor outside the door via the camera on the doorbell intercom; therefore, if a suspicious person is at the door, the door can be kept closed and reporting to police agency can be made in order to ensure the safety the house owner.

Nevertheless, during the use of the aforementioned doorbell intercom, the following drawbacks are known such that further improvements are necessary:

The display monitor of the doorbell intercom is typically installed adjacent to the door inside the house, and when the electronic bell generates a sound, the house owner still needs to walk to the display monitor in order to view the images at the door. In other words, the house owner cannot move and portably carry the display monitor at the same time in order to know the situation outside the house readily, which is inconvenient to the user. Moreover, if the house owner is not inside the house, he or she cannot view images at the door such that the chance of burglar intruding into the house is increased, leading to possible loss of properties of the house owner and even hazards to the safety of the house owner.

### SUMMARY OF THE INVENTION

A primary objective of the present invention is to utilize the design of a camera module in order to allow a user to monitor outdoor conditions.

Another primary objective of the present invention is to utilize the design of a wireless network communication device in order to allow a user to perform remote monitoring and control on the network camera device via a mobile device.

To achieve the aforementioned objectives, the present invention provides a multi-functional network camera control apparatus, comprising: at least one network camera device comprising at least one camera module, at least one first computation processing device, at least one wireless network communication device for establishing a wireless information connection with at least one mobile device, and at least one first wireless transceiving device; and a wireless key operation device installed at one side of the network camera device and configured to establish a wireless information connection with the network camera device; the wireless key operation device comprising at least one key module, at least one second computation processing device and at least one second wireless transceiving device; wherein the second wireless transceiving device establishes a wireless information connection with the first wireless transceiving device. Accordingly, a visitor can press the key module on the wireless key operation device, and the second computation processing device then transmits information to the network camera device via the connection established between the second wireless transceiving device and the first wireless transceiving device in order to activate the camera module and to notify the user via the wireless network communication device. Consequently, the house owner can view images of the visitor from the mobile device and can also monitor the environment conveniently.

### BRIEF DESCRIPTION OF THE DRAWINGS

FIG. 1 is a perspective see-through view of the present invention;

FIG. 2 is a structural block diagram of the present invention;

FIG. 3 is a schematic view (1) showing an implementation of the present invention;

FIG. 4 is a schematic view (2) showing another implementation of the present invention; and

FIG. 5 is a schematic view (3) showing still another implementation of the present invention.

### DETAILED DESCRIPTION OF THE PREFERRED EMBODIMENTS

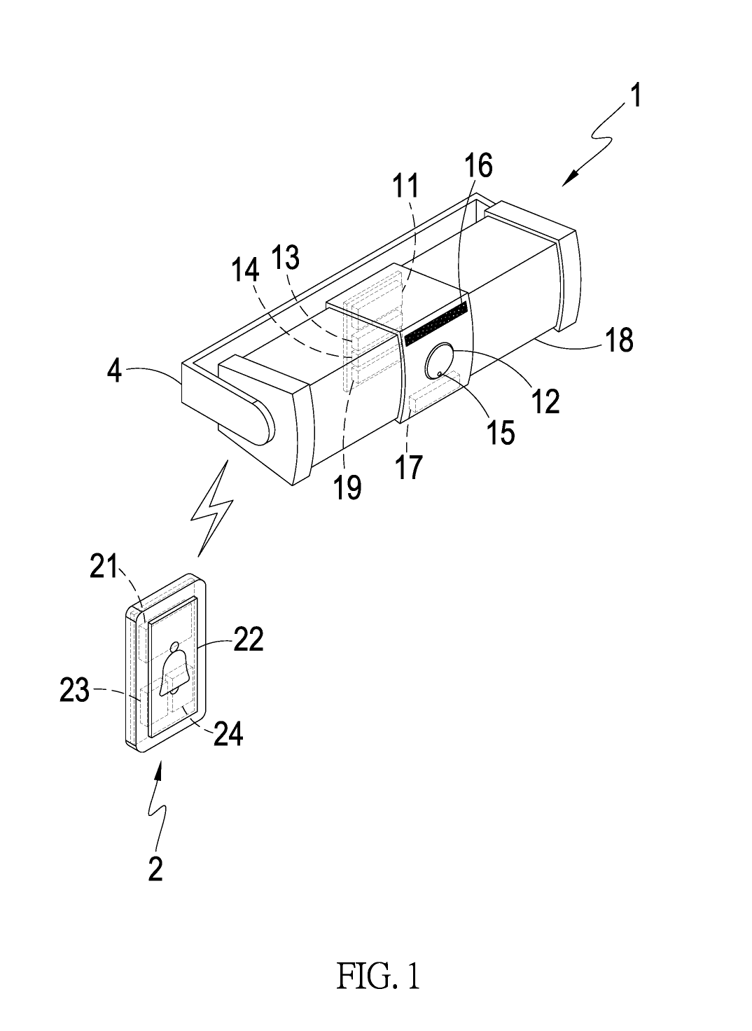

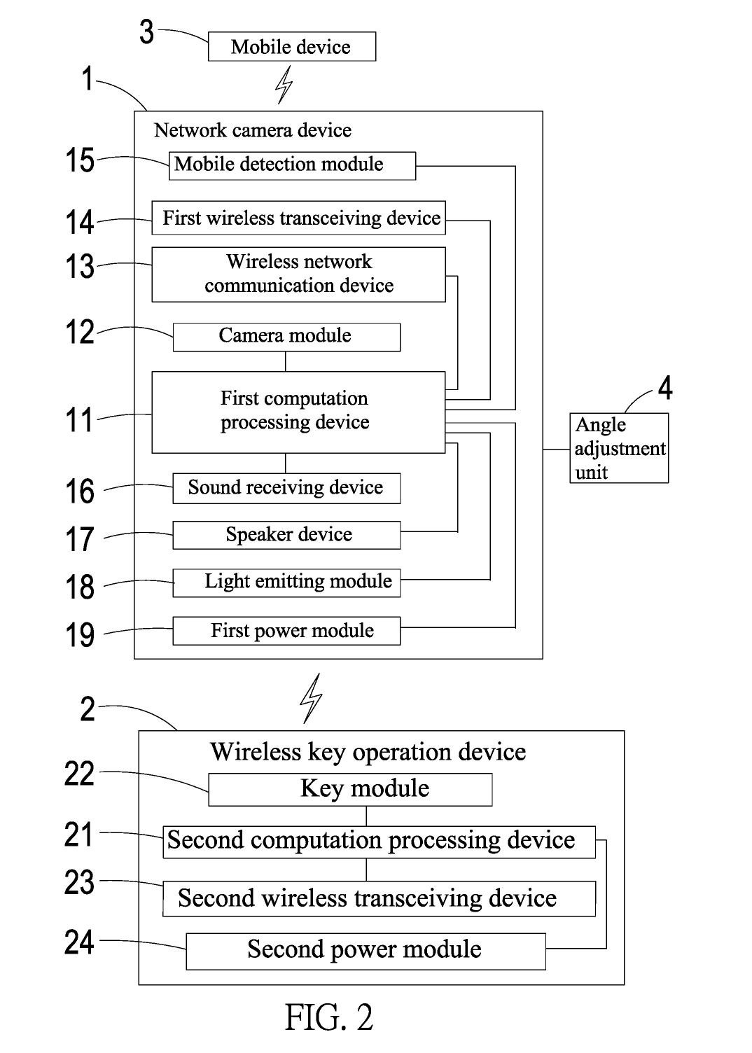

As shown in FIG. 1 and FIG. 2, the present invention provides a multi-functional network camera control apparatus, comprising at least one network camera device. The network camera device 1 further comprises at least one camera module 12, at least one first computation processing device 11 installed at one side of the camera module 12 and electrically connected thereto, at least one wireless network communication device 13 installed at one side of the first computation processing device 11 and electrically connected thereto in order to establish a wireless information connection with at least one mobile device 3, and at least one first wireless transceiving device 14 installed at one side of the wireless network communication device 13 and electrically connected to the first computation processing device 14. In addition, the mobile device 3 is a smartphone.

Furthermore, another side of the camera module 12 includes at least one movement detection module 15 installed thereon and electrically connected to the first computation processing device 11 in order to detect a movement of a human body, and another side of the camera module 12 includes at least one sound receiving device 16 electrically connected the first computation processing device 11.

Moreover, another side of the first computation processing device 11 includes at least one light emitting module 18 electrically connected thereto, and another side of the first computation processing device 11 includes at least one first power module 19 electrically connected thereto. In addition, another side of the first computation processing device 11 includes at least one speaker device 17 electrically connected thereto.

According to an embodiment of the present invention, the multi-functional network camera control apparatus further comprises a wireless key operation device 2 installed at one side of the network camera device 1 and configured to establish a wireless information connection with the network camera device 1. The wireless key operation device 2 comprises at least one key module 22, at least one second computation processing device 21 installed at one side of the key module 22 and electrically connected thereto, and at least one second wireless transceiving device 23 installed at one side of the second computation processing device 21 and electrically connected thereto. In addition, the second wireless transceiving device 23 establishes a wireless information connection with the first wireless transceiving device 14.

Furthermore, another side of the key module 12 includes at least one second power module 24 electrically connected to the second computation processing device 21.

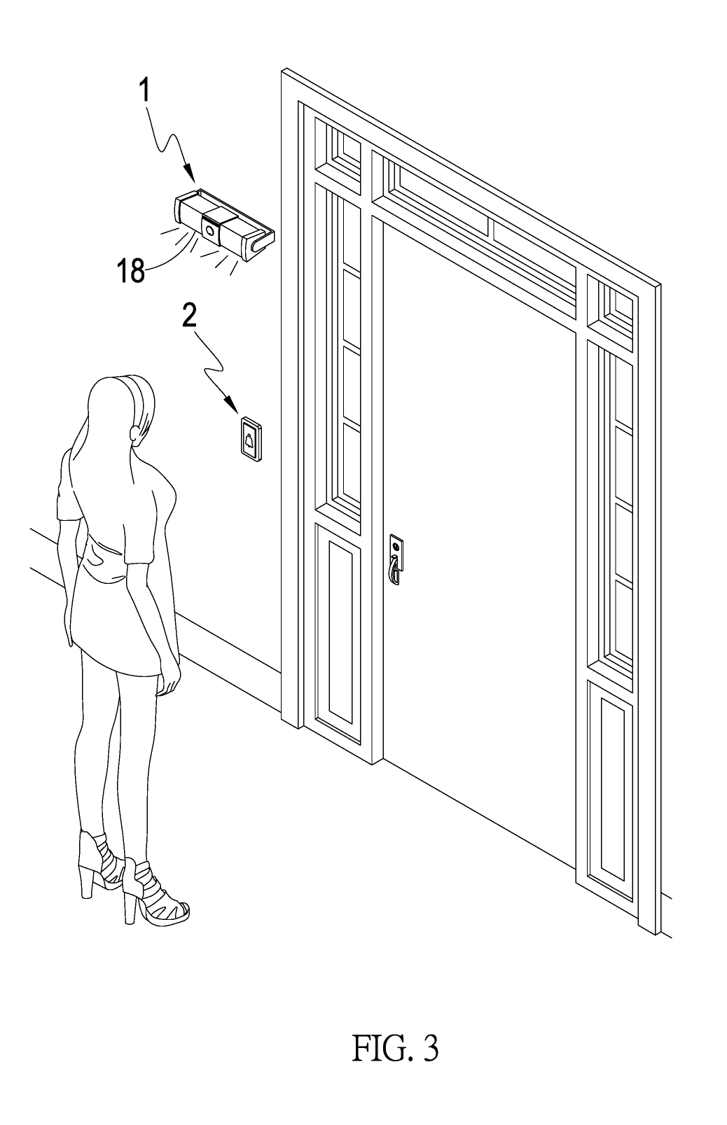

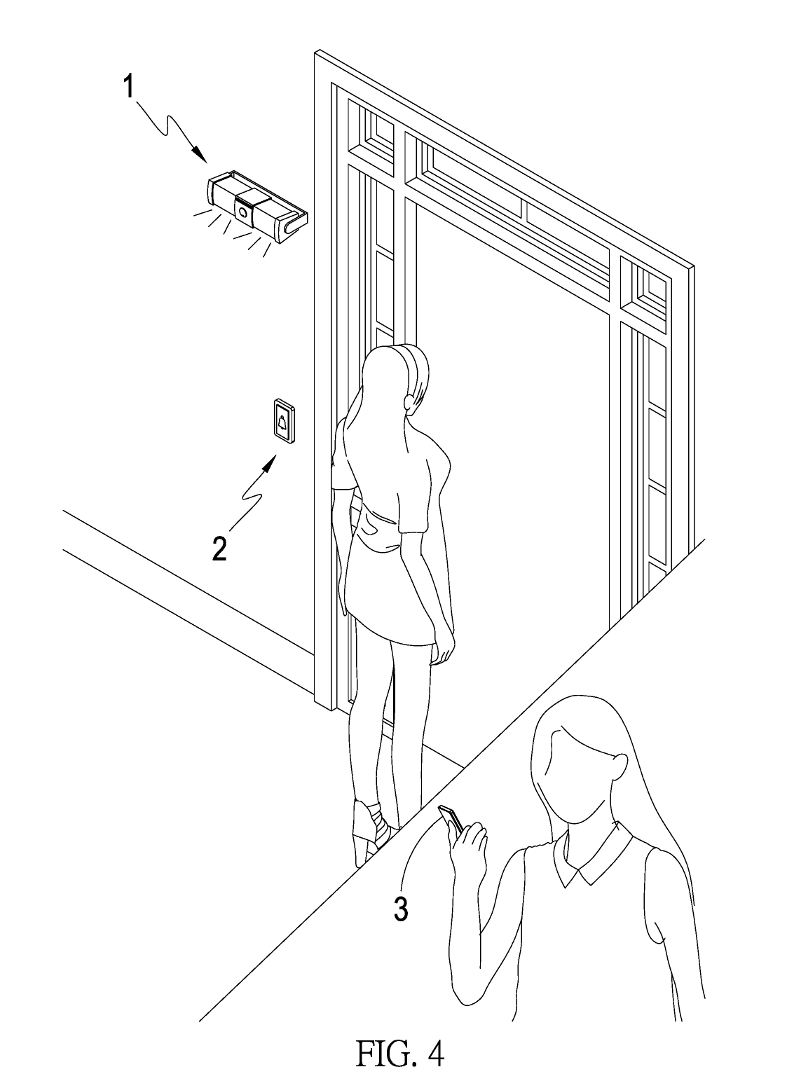

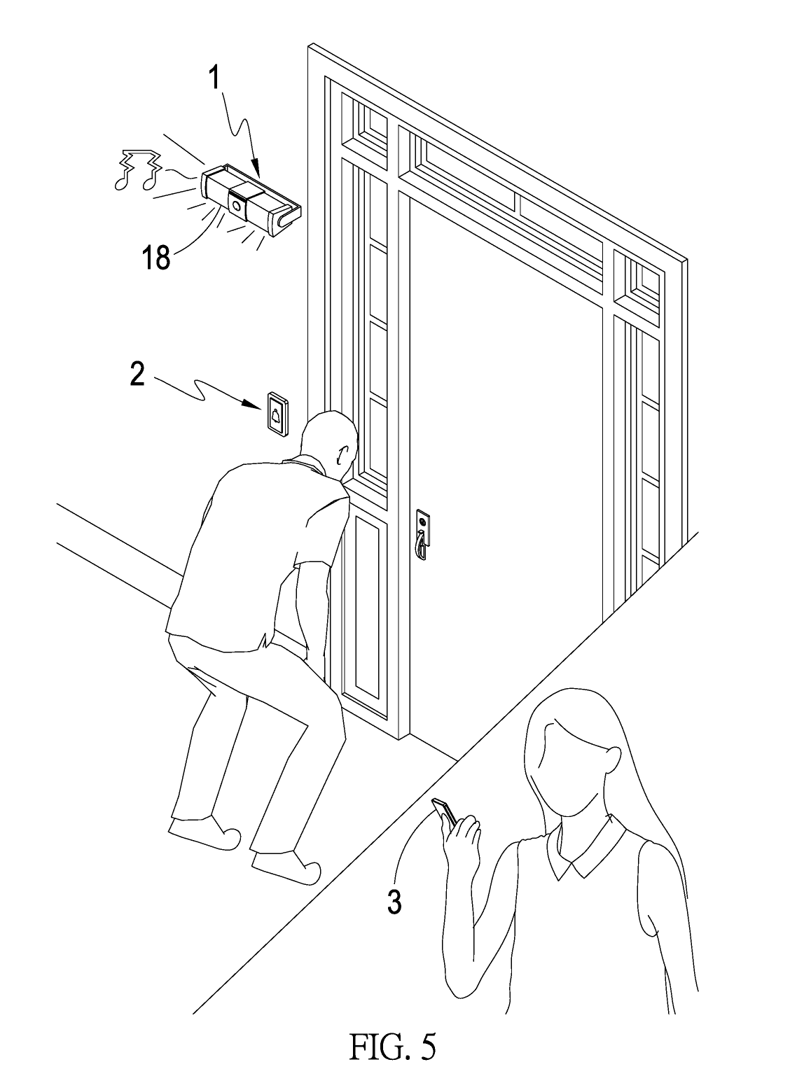

As shown in FIG. 1 to FIG. 5, the movement detection module 15 on the network camera device 1 is an infrared sensor such that when a person approaches, the person is detected by the movement detection module 15. The first computation processing device 11 receives the detection signal from the movement detection module 15 and activates the light emitting module 18 in order to provide illumination. On the other hand, when the person is away from the detection range the movement detection module 15, the movement detection module 15 transmits a signal to the first computation processing device 11 to shut down the light emitting module 18 in order to turn off the illumination. In addition, the house owner can also press the key module 22 on the wireless key operation device 2 in order to trigger the second computation processing device 21. Through the connection established between the first wireless transceiving device 14 and the second wireless transceiving device 23, the pressing signal of the key module 22 can be transmitted to the first computation processing device 11 in order to control the light emitting module 18. For situation where there is a visitor at the door, the visitor can press the key module 22 to call the house owner. When the second computation processing device 21 detects that the key module 22 is pressed, it is able to transmit a signal via the second wireless transceiving device, and the first wireless transceiving device 14 is able to receives the signal and transmit to the first computation processing device 11 for processing. Therefore, the wireless network communication device 13 is able to use the network connection to inform the house owner to answer the door via the mobile device 3. The house owner can then use the mobile device 3 to view the real-time images of the visitor taken by the camera module 12 and to perform voice communication with the visitor via the speaker device 17 and the sound receiving device 16 on the network. In the event where there is an intruder attempting to enter into the house, once the intruder enters into the detection range of the movement detection module 15, the movement detection module 15 then notifies the first computation processing device 11 to activate the camera module 12 in order to perform recording and to inform the user via the wireless network communication 13 to monitor the real-time images of the intruder via the mobile device 3. Moreover, the user can also use the speaker device 17 and the sound receiving device 16 to generate voice communications in order to warn the intruder. When the user has the need to make emergency calls or alarms, he or she can press the key module 22 on the wireless key operation device 2 or the emergency button set up in the software of the mobile device 3 in order to connect to the network camera device 1 for controlling the light emitting module 18 to generate alarm flashing lights, and the speaker device 17 can also generate alarm buzzer at the same time to attack the attention of surrounding people such that the intruder or burglar can be warned and prohibited. Furthermore, the network camera device 1 can send out notification messages to mobile devices 3 of people capable of providing assistance via the wireless network communication device 13 in order to seek for necessary assistance. In addition, the first power module a19 and the second power module 24 are batteries capable of providing the electrical power necessary for the network camera device 1 and the wireless key operation device 2. Moreover, the network camera device 1 includes an angle adjustment unit 4 installed thereon and provided for adjusting an angle of the network camera device 1 in order to allow the network camera device 1 to achieve adjustments at multiple angles and directions during the installation of the device such that the monitoring range of the network camera device 1 is increased to ensure the safety of the environment.

I claim:

1. A multi-functional network camera control apparatus, comprising:
at least one network camera device comprising at least one camera module, at least one first computation processing device installed at one side of the camera module and electrically connected thereto, at least one wireless network communication device installed at one side of the first computation processing device and electrically connected thereto in order to establish a wireless information connection with at least one mobile device, and at least one first wireless transceiving device installed at one side of the wireless network communication device and electrically connected to the first computation processing device; and
a wireless key operation device installed at one side of the network camera device and configured to establish a wireless information connection with the network camera device; the wireless key operation device comprising at least one key module, at least one second computation processing device installed at one side of the key module and electrically connected thereto, and at least one second wireless transceiving device installed at one side of the second computation processing device and electrically connected thereto; wherein the second wireless transceiving device establishes a wireless information connection with the first wireless transceiving device.

2. The multi-functional network camera control apparatus according to claim 1, wherein another side of the camera module includes at least one movement detection module installed thereon and electrically connected to the first computation processing device in order to detect a movement of a human body.

3. The multi-functional network camera control apparatus according to claim 1, wherein another side of the first computation processing device includes at least one light emitting module electrically connected thereto.

4. The multi-functional network camera control apparatus according to claim 1, wherein another side of the first computation processing device includes at least one first power module electrically connected thereto.

5. The multi-functional network camera control apparatus according to claim 1, wherein another side of the camera module includes at least one sound receiving device electrically connected the first computation processing device.

6. The multi-functional network camera control apparatus according to claim 1, wherein another side of the first computation processing device includes at least one speaker device electrically connected thereto.

7. The multi-functional network camera control apparatus according to claim 1, wherein another side of the key module includes at least one second power module electrically connected to the second computation processing device.

8. The multi-functional network camera control apparatus according to claim 1, wherein the network camera device includes at least one angle adjustment unit installed thereon and provided for adjusting an angle of the network camera device.

9. The multi-functional network camera control apparatus according to claim 1, wherein the mobile device is a smartphone.
